(19) United States
(12) Patent Application Publication
(10) Pub. No.: US 2007/0006779 A1
(43) Pub. Date: Jan. 11, 2007

(54) Composition

(76) Inventors: Davide Zampini, Orpun (CH); Martin Weibel, Zurich (CH); Andre Walliser, Pratteln (CH); Max Oppliger, Allschwil (CH)

Correspondence Address: CURATOLO SIDOTI CO., LPA, 24500 CENTER RIDGE ROAD, SUITE 280, CLEVELAND, OH, 44145, US

(21) Appl. No.: 10/551,982

(22) PCT Filed: Mar. 5, 2004
(86) PCT No.: PCT/EP04/02255

§ 371 Date: Jun. 23, 2006

(30) Foreign Application Priority Data
Apr. 7, 2003 (GB) 0307948.0

(51) Int. Cl. C04B 24/42

(52) U.S. Cl. 106/806

(57) ABSTRACT

A composition for improving the properties of a cementitious composition comprises a fluid blend of at least one polyalkylene oxide, at least one aqueous paraffin emulsion, at least one siloxane and, if necessary for fluidity, water.

This invention relates to chemical compositions which bring about improvements in the properties of cementitious compositions.

The chemical composition comprises a fluid blend of
(i) at least one polyalkylene oxide, the alkylene oxide units being ethylene and propylene oxides;
(ii) at least one aqueous paraffin emulsion; and
(iii) at least one siloxane compound that is at least one of liquid and soluble in at least one of water and aqueous alkali.

By “siloxane compound” is meant any siloxane-based material, that is, a material having a linear or branched siloxane backbone chain of the form —SiR^{a}R^{b}—O—SiR^{c}R^{d}—O—. Any such material will work in this invention, provided that it is liquid or at least slightly soluble in at least one of water and aqueous alkali.

Preferred siloxane compounds for use in this invention are selected from those that correspond to the general formula I 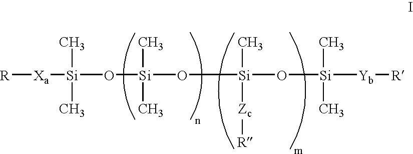
where m and n are independently from 1-2000, preferably from 1-500 and more preferably from 1-200, a, b, and c are independently either 0 or 1 and X, Y and Z are selected from -O-;

-O-CH₂)₁₋₃₀—, this moiety being at least one of linear, branched and containing at least one ring;

-(CH₂)₁₋₃₀—, this moiety being at least one of linear, branched and containing at least one ring;
-CH₂-CH₂-CH₂—O —;
-CH₂-CH₂-CH₂-0-CH₂-CHOH-CH₂-;
-CH₂-CH₂-CH₂-0-CH₂-CHOH-CH₂-0-;
-CH₂-CH₂-CH₂-0-CH₂-CHOH-CH₂-N-; and R, R′ and R″ are independently selected from at least one of hydrogen, C₁₋₁₀₀ alkyl, C₆₋₃₀ aryl, C₇₋₃₀ aralkyl; C₇₋₃₀ alkaryl; C₁₋₃₀ hydroxyalkyl; C₃₋₂₀₀ polyhydroxyalkyl; polyether consisting of from 2-200 identical or different C₁₋₁₅ oxyalkylene units; C₁₋₃₀ aminoalkyl; polyiminopolyalkylene having from 1-20 identical or different C₂₋₁₅ alkylene units; polyiminopolyoxyalkylene having from 1-20 identical or different C₂₋₁₅ oxyalkylene units; C₃₋₃₀ quaternary ammonium, optionally completely or partially ionised with at least one anion; C₄₋₃₀ betaine; carboxyl, optionally completely or partially ionised with any suitable cation; C₄₋₃₀ polycarboxyalkyl, optionally completely or partially ionised with at least one cation; sulpho group, optionally completely or partially ionised with at least one cation; thiosulpho group, optionally completely or partially ionised with at least one cation; epoxide group; glycidyl; acrylate; C₁₋₃₀ ester; polyester consisting of from 2-200 C₂₋₁₅ diacid and diester monomer units; and esters of inorganic acids, all alkyl chains being at least one of linear, branched and comprising at least one ring.

A more preferred class of siloxane compounds comprises those of Formula I in which a, b, and c are all 1 and X, Y and Z are selected from
-O-(CH₂)₁₋₃₀-, this moiety being linear or branched;
-(CH₂)₁₋₃₀-, this moiety being linear or branched;
-CH₂-CH₂-CH₂-O-CH₂-CHOH-CH₂-;
   and R, R′ and R″ are independently selected from at least one of hydrogen; hydroxy; polyether consisting of from 2-200 identical or different C₂₋₆ oxyalkylene units, with the proviso that, if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; sulpho group, optionally completely or partially ionised with at least one cation; thiosulpho group, optionally completely or partially ionised with at least one cation; glycidyl; and acrylate; all alkyl chains being at least one of linear, branched and comprising at least one ring.

An even more preferred class of siloxane compounds comprises those of Formula I in which m and n are independently selected from 1-200, a, b, and c are all 1 and X, Y and Z are selected from
-O-(CH₂)₁₋₁₂-;
-(CH₂)₁₋₁₂-;
-CH₂-CH₂-CH₂-O-CH₂-CHOH-CH₂-;
   and R, R′ and R″ are independently selected from at least one of hydrogen; hydroxy; polyether consisting of from 2-200 identical or different C₂₋₆ oxyalkylene units, with the proviso that, if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; glycidyl; and acrylate; all alkyl chains being capable of being linear or branched.

An even more preferred class of siloxane compounds comprises those of Formula I in which m is from 1-30 and n is from 1-100, a, b, and c are all 1 and X, Y and Z are selected from
-O-(CH₂)₁₋₆-;
-(CH₂)₁₋₆-;
-CH₂-CH₂-CH₂-O-CH₂-CHOH-CH₂-;
   and R, R′ and R″ are independently selected from at least one of hydrogen; hydroxy; polyether consisting of from 2-200 identical or different C₂₋₆ oxyalkylene units, with the proviso that, if there is present more than one type of oxyalkylene unit, there shall be present at least two of each unit; C₃₋₂₀ quaternary ammonium, optionally completely or partially ionised with at least one anion; C₄₋₁₀ betaine and carboxyl, optionally completely or partially ionised with at least one cation; all alkyl chains being capable of being linear or branched.

The siloxanes hereinabove described may be any such material known to the art. Such materials are well known to the art for a variety of purposes, one of these being as antifoams in various industries. The preferred materials are those where R and R′ are methyl or ethyl, n is from 5-200, more preferably from 10-150 and most preferably from 40-100, and m is from 1-100, more preferably from 2-40 and most preferably from 5-10.

The two different types of siloxane units may be arranged randomly or in blocks on the molecule. It is possible to utilise more than one type of moiety R″. Examples of R″ include ethylene oxide - propylene oxide copolymers of from 10 to 100 units.

The siloxanes that are useful in the present invention may either be incorporated into a dry cementitious composition, or they may be added to such a composition when it is mixed with water immediately prior to placement. The quantity required depends on the type of cement and the precise nature of the siloxane, but a typical range of weight proportions is from 0.05%-20% by weight of the weight of the cement, more preferably from 0.1-5%, even more preferably from 0.1-2% and most preferably from 0.2-1%.

In a further embodiment of the invention, the siloxane may be used in conjunction with hydrophobic, finely-divided silica. This can be added to the composition separately from the siloxane, but it is preferred that it be incorporated into the siloxane by, for example, blending or mixing. The quantity of silica can be up to 20% by weight of the siloxane, preferably no more than 10%. In a yet further embodiment of the invention, the siloxane may additionally contain emulsifier. Any suitable emulsifiers may be used in art-recognised quantities. Some commercially-available emulsifiers already contain emulsifier, so addition may be unnecessary.

Preferably the polyalkylene oxide is polyethylene oxide. The weight-average molecular weight is from 100,000-8,000,000, preferably from 2,000,000-5,000,000.

There are many types of paraffin emulsions available and any of these may be used in the working of the invention. By “paraffin emulsion” is meant an aqueous emulsion of a higher alkane having a fusion point above ambient temperature, which upon drying of the emulsion does not form a film in the sense that a paint forms a film (see also Rompp “Chemie Lexikon”, 9th edition (Thieme Verlag 1989), volume 1, page 102, the contents of which are incorporated herein by reference). The emulsion may be stabilised by any convenient means, but it is preferable to use an ionically-emulsified (preferably anionically-stabilised) paraffin mixture (fusion point of 45-51° C.) with a particle size of less than 2 μM. Examples of such paraffin emulsions are “Mobilcer” 55 or “Mulrex” 62 from Mobil and “Ubatol” FPG 860 from Cray Valley and “Tecol” BC 60/40 from Trüb Emulsion Chemie.

The concentrations of the three ingredients and water in the chemical composition are shown below (as percentages by weight of the total composition). In some cases, the blend of the three ingredients is sufficiently fluid to make any water unnecessary, but generally some water is necessary, sometimes in relatively high proportion (when, for example, the polyethylene oxide is of high molecular weight).

| | Widest limits | preferred | more preferred |
|---|---|---|---|
| siloxane | 5-60 | 10-50 | 20-40 |
| paraffin wax | 10-70 | 20-60 | 30-50 |
| polyethylene oxide | 0.1-5 | 0.2-2 | 0.5-1.5 |
| water | 0-80 | 20-70 | 30-50 |

The three materials may be mixed into a dry cement, mortar or concrete mix, to which water need only be added, or they may be added individually or collectively in any combination to a cementitious mix when water is being added, prior to final use. It is preferred to combine the three (with water if necessary) in a single admixture. The material has a long shelf life and is ready for use without any prior preparation. In use, the chemical composition is added in a quantity of from 0.01-100% by weight on cement. The water content may be varied over wide limits, depending on the effect desired. It is preferred to have relatively little water content, i.e., preferably less than 50% by weight of the composition. In such a case, the preferred quantity by weight on cement is from 0.05-10%, more preferably from 0.1-3% and most preferably from 0.2-2%.

The use of the composition has a considerable and highly beneficial effect on any cementitious composition in which it is incorporated. Not only is the shrinkage and cracking decreased or even eliminated, as hereinabove described, but there may also be noticeable improvements in properties such as freeze-thaw resistance and permeability, and there can also be a significant plasticising effect. The nature and extent of improvement will depend on the type of cementitious mix and the natures and concentrations of the various constituent raw materials, but there is always some enhancement. The invention therefore also provides a method of modifying the properties of a cementitious composition, comprising adding to a fluid cementitious mix a chemical composition as hereinabove described. The invention further provides a cementitious composition having improved properties, which composition comprises a chemical composition as hereinabove described.

In addition to the one or three materials hereinabove described, there can also be added to the cementitious mix materials known to the art for the performance of particular functions, in art-recognised quantities. Such materials include (but are not limited to) plasticisers and superplasticisers, accelerators, antifreeze agents, pigments, air-entraining agents, retarders and reinforcing fibres of metal, glass or polymer.

The invention is further described with reference to the following non-limiting examples.

A number of materials are tested in a standard concrete mix, the mix design being as follows:

| | | |
|---|---|---|
| Cement | 450 kg/m³ | |
| Aggregate | 0-4 mm | 990 kg/m³ |
| | 4-8 mm | 660 kg/m³ |

Water-to-cement ratio=0.47

The Materials Tested are as Follows:

Admixture 1—a blend of a commercial paraffin wax emulsion (“Tecol” BC 60/40 from Trüb Emulsion Chemie) and a polyethylene oxide of MW 4,000,000 (“Polyox” (trade mark) 301 from Union Carbide), the blend containing 40% by weight paraffin emulsion and 1% polyethylene oxide

Admixture 2—Admixture 1+siloxane (a polyether siloxane wherein m+n=75, having on average per molecule 6.5 ethylene oxide/propylene oxide side chains of MW 1800)

Admixture 3—a commercial neopentyl glycol-based shrinkage reducing agent.

Admixture 4—a commercial shrinkage-reducing agent which is a blend of polyoxyalkylene ethers.

In all cases, 1% admixture by weight of cement is used, except in the case of Admixture 2, where 1% each of Admixture 1 and siloxane are used.

The drying free shrinkage is measured by German Standard Test Method DIN 52 450.

The results are shown in the following table:

Drying free shrinkage (mm/m)

| Age | No | Admixture | Admixture | Admixture | Admixture |
|---|---|---|---|---|---|
| (days) | admixture | 1 | 2 | 3 | 4 |
| 1 | 0 | 0 | 0 | 0 | 0 |
| 3 | 0.068 | 0.077 | −0.044 | 0.026 | −0.011 |
| 7 | 0.173 | 0.177 | −0.004 | 0.129 | 0.046 |
| 14 | 0.233 | 0.226 | 0.028 | 0.203 | 0.127 |
| 21 | 0.283 | 0.294 | 0.066 | 0.234 | 0.157 |
| 28 | 0.328 | 0.329 | 0.102 | 0.272 | 0.213 |
| 38 | 0.365 | 0.359 | 0.121 | 0.282 | 0.223 |
| 58 | 0.416 | 0.423 | 0.193 | 0.35 | 0.281 |
| 67 | 0.433 | 0.428 | 0.233 | 0.387 | |
| 87 | 0.473 | 0.485 | 0.271 | 0.389 | 0.341 |

It can be seen that the performance of Admixture 2 is appreciably better than that of the other admixtures. It is particularly noteworthy that the shrinkage performance of Admixture 1 goes from being the worst to the best, when it is augmented by siloxane to give Admixture 2. In addition, it is found that the cementitious mix flows better and that the final cementitious composition is less permeable to water than an identical composition but without the chemical composition.

1. A composition for improving the properties of a cementitious composition,
comprising a fluid blend of
(i) at least one polyalkylene oxide, wherein the alkylene oxide units are at least one of ethylene or propylene oxides;
(ii) at least one aqueous paraffin emulsion; and
(iii) at least one siloxane compound that is at least one of liquid or soluble in at least one of water or aqueous alkali.

2. The composition according to claim 1, in which the siloxane compound is selected from those that correspond to the general formula I: 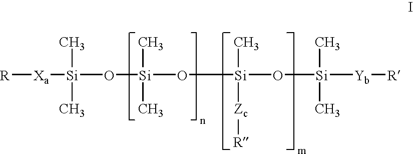
where m and n are independently from 1-2000, a, b, and c are independently either 0 or 1 and X, Y and Z are selected from
-O-;
-O-(CH2)₁₋₃₀-, this moiety is at least one of linear, branched or containing at least one ring;
-(CH2)₁₋₃₀-, this moiety is at least one of linear, branched or containing at least one ring;
-CH₂-CH₂-CH₂-O-;
-CH₂-CH₂-CH₂-O-CH₂-CHOH-CH₂-;
-CH₂-CH₂-CH₂-O-CH₂-CHOH-CH₂-O-; and
-CH₂-CH₂-CH₂-O-CH₂-CHOH-CH₂-N-; and R, R′ and R″ are independently selected from at least one of hydrogen, C₁₋₁₀₀ alkyl, C₆₋₃₀ aryl, C₇₋₃₀ aralkyl; C₇₋₃₀ alkaryl; C₁₋₃₀ hydroxyalkyl; C₃₋₂₀₀ polyhydroxyalkyl; polyether consisting of from 2-200 identical or different C₁₋₁₅ oxyalkylene units; C₁₋₃₀ aminoalkyl; polyiminopolyalkylene having from 1-20 identical or different C₂₋₁₅ alkylene units; polyiminopolyoxyalkylene having from 1-20 identical or different C₂₋₁₅ oxyalkylene units; C₃₋₃₀ quaternary anmmonium, optionally completely or partially ionised with at least one anion; C₄₋₃₀ betaine; carboxyl, optionally completely or partially ionised with at least one cation; C₄₋₃₀ polycarboxyalkyl, optionally completely or partially ionised with at least one cation; sulpho group, optionally completely or partially ionised with at least one cation; thiosulpho group, optionally completely or partially ionised with at least one cation; epoxide group; glycidyl; acrylate; CI-30ester; polyester consisting of from 2-200 C₂₋₁₅ diacid and diester monomer units; and esters of inorganic acids, wherein all alkyl chains are at least one of linear, branched or comprise at least one ring.

3. The composition according to claim 2, wherein the siloxane compound is selected from those of Formula I in which a, b, and c are all 1 and X, Y and Z are selected from
-O-(CH₂)₁₋₃₀-, this moiety is linear or branched;
-(CH₂)₁₋₃₀-, this moiety is linear or branched; and
-CH₂-CH₂-CH₂-O-CH₂-CHOH-CH₂-;
and R, R′ and R″ are independently at least one of hydrogen; hydroxy; polyether consisting of from 2-200 identical or different C₂₋₆ oxyalkylene units, wherein if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; sulpho group, optionally completely or partially ionised with at least one cation; thiosulpho group, optionally completely or partially ionised with at least one cation; glycidyl; and acrylate; wherein all alkyl chains are at least one of linear, branched or comprise at least one ring.

4. The composition according to claim 2, in which the siloxane compound is selected from those of Formula I in which m and n are independently selected from 1-200, a, b, and c are all 1 and X, Y and Z are selected from
-O-(CH₂)₁₋₁₂-;
-(CH₂)₁₋₁₂-; and
-CH₂-CH₂-CH₂-O-CH₂-CHOH-CH₂-;
and R, R′ and R″ are independently at least one of hydrogen; hydroxy; polyether consisting of from 2-200 identical or different C₂₋₆ oxyalkylene units, wherein, if there is present more than one type of oxyalkylene unit, there shall be present at least two of each unit; C₃₋₃₀ quaternary ammonium, optionally completely or partially ionised with at least one anion; C₄₋₃₀betaine; carboxyl, optionally completely or partially ionised with at least one cation; glycidyl; or acrylate; wherein all alkyl chains may be linear or branched.

5. The composition according to claim 2, in which the siloxane compound is selected from those of Formula I in which m is from 1-30 and n is from 1-100, a, b, and c are all 1 and X, Y and Z are selected from
O-(CH₂)₁₋₆;
-(CH₂)₁₋₆-; and
-CH₂-CH₂-CH₂-O-CH₂-CHOH-CH₂-;
and R, R′ and R″ are independently selected from at least one of hydrogen; hydroxy;
polyether consisting of from 2-200 identical or different C₂₋₆ oxyalkylene units, wherein, if there is present more than one type of oxyalkylene unit, there shall be present at least two of each unit; C₃₋₂₀ quaternary ammonium, optionally completely or partially ionised with at least one anion; C₄₋₁₀ betaine and carboxyl, optionally completely or partially ionised with at least one cation; wherein all alkyl chains may be linear or branched.

6. The composition according to claim 1 in which the polyalkylene oxide is polyethylene oxide.

7. The composition according to claim 1 in which the weight-average molecular weight of the polyalkylene oxide is 100,000-8,000,000.

8. The composition according to claim 1 in which the paraffin emulsion is an ionically-emulsified paraffin mixture with a fusion point of 45-51° C. and a particle size of less than 2μm.

9. A method of modifying the properties of a cementitious composition, comprising adding to a fluid cementitious mix a composition according to claim 1.

10. A cementitious composition having improved properties, wherein the cementitious composition comprises a chemical composition according to claim 1.

11. The composition according to claim 2, wherein m and n are independently from 1 to 500.

12. The composition according to claim 2, wherein R and R′ are methyl or ethyl.

13. The composition according to claim 2, wherein R″ comprises ethylene oxide-propylene oxide copolymers of from 10 to 100 units.

14. The cementitious composition according to claim 10, wherein the amount of siloxane compound is from 0.05% to 20% by weight of the cement.

15. The cementitious composition according to claim 10, comprising finely-divided silica.

16. The cementitious composition according to claim 15, wherein the composition comprises finely-divided silica up to 20% by weight of the siloxane compound.

17. The composition according to claim 1, wherein the composition comprises an emulsifier.

18. The cementitious composition according to claim 10, comprising at least one of plasticizers, superplasticisers, antifreeze agents, pigments, air-entraining agents, accelerators, retarders or reinforcing fibres that are comprised of at least one of metal, glass or polymer.

19. The cementitious composition according to claim 10, in which the siloxane compound is selected from those that correspond to the general formula I: 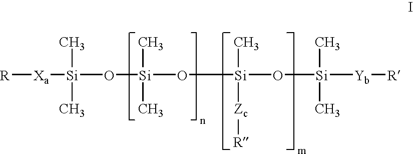
where m and n are independently from 1-2000, a, b, and c are independently either 0 or 1 and X, Y and Z are selected from
-O-;
-O-(CH₂)₁₋₃₀-, this moiety is at least one of linear, branched or containing at least one ring;
-(CH₂)₁₋₃₀-, this moiety is at least one of linear, branched or containing at least one ring;
-CH₂-CH₂-CH₂-O-;
-CH₂-CH₂-CH₂-O-CH₂-CHOH-CH₂-;
-CH₂-CH₂-CH₂-O-CH₂-CHOH-CH₂-O-; and
-CH₂-CH₂-CH₂-O-CH₂-CHOH-CH₂-N-;
and R, R′ and R″ are independently selected from at least one of hydrogen, C₁₋₁₀₀ alkyl, C₆₋₃₀ aryl, C₇₋₃₀ aralkyl; C₇₋₃₀ alkaryl; C₁₋₃₀ hydroxyalkyl; C₃₋₂₀₀ polyhydroxyalkyl; polyether consisting of from 2-200 identical or different C₁₋₁₅ oxyalkylene units; C₁₋₃₀ aminoalkyl; polyiminopolyalkylene having from 1-20 identical or different C₂₋₁₅ alkylene units; polyiminopolyoxyalkylene having from 1-20 identical or different C₂₋₁₅ oxyalkylene units; C₃₋₃₀ quaternary ammonium, optionally completely or partially ionised with at least one anion; C₄₋₃₀ betaine; carboxyl, optionally completely or partially ionised with at least one cation; C₄₋₃₀ polycarboxyalkyl, optionally completely or partially ionised with at least one cation; sulpho group, optionally completely or partially ionised with at least one cation; thiosulpho group, optionally completely or partially ionised with at least one cation; epoxide group; glycidyl; acrylate; C₁₋₃₀ ester; polyester consisting of from 2-200 C₂₋₁₅ diacid and diester monomer units; and esters of inorganic acids, wherein all alkyl chains are at least one of linear, branched or comprise at least one ring.

20. The cementitious composition according to claim 19, wherein the siloxane compound is selected from those of Formula I in which a, b, and c are all 1 and X, Y and Z are selected from
-O-(CH₂)₁₋₃₀-, this moiety is linear or branched;
-(CH₂)₁₋₃₀-, this moiety is linear or branched; and
-CH₂-CH₂-CH₂-O-CH₂-CHOH-CH₂-;
and R, R′ and R″ are independently at least one of hydrogen; hydroxy; polyether consisting of from 2-200 identical or different C₂₋₆ oxyalkylene units, wherein if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; sulpho group, optionally completely or partially ionised with at least one cation; thiosulpho group, optionally completely or partially ionised with at least one cation; glycidyl; and acrylate; wherein all alkyl chains are at least one of linear, branched or comprise at least one ring.
